(19) United States
(12) Patent Application Publication
(10) Pub. No.: US 2005/0072866 A1
(43) Pub. Date: Apr. 7, 2005

(54) Turbulent flow reducer

(76) Inventor: Kevin J. Petit, Wooster, OH (US)

Correspondence Address: H. Duane Switzer;Jones Day, North Point, 901 Lakeside Avenue, Cleveland, OH, 44114, US

(21) Appl. No.: 10/676,751

(22) Filed: Oct. 1, 2003

(51) Int. Cl. B05B 1/14

(52) U.S. Cl. 239/590; 239/590.3; 239/590.5

(57) ABSTRACT

A stream shaper for reducing turbulent flow has a plurality of circumferentially-spaced vanes, with alternate vanes being axially-spaced from the remaining vanes. This axial separation of vane groups reduces the flow restriction caused by the vanes at any given cross section along the length of the stream shaper as compared to a stream shaper having the same total number of vanes extending the full length of the stream shaper. Axially spacing alternate vanes from the remaining vanes also permits a significant reduction in the overall length of the stream shaper while providing the turbulence reducing effects of a much longer stream shaper with vanes that extend uninterrupted the full length of the stream shaper.

### BACKGROUND OF THE INVENTION

This application relates to the art of fluid flow control and, more particularly, to reducing turbulence in a flowing stream. The invention is particularly applicable for use with firefighting nozzles and will be described with specific reference thereto. However, it will be appreciated that the invention has broader aspects and can be used in any environment for reducing turbulence in a fluid stream.

Turbulence in the water delivered to a discharge nozzle reduces the reach of the water jet discharged from the nozzle and causes water to separate from the jet instead of being delivered to the desired location. Separation of liquid from the discharged water jet is visible as a mist that produces a long footprint where the water falls to the ground.

Early efforts to reduce turbulence included the use of a long smooth discharge pipe upstream from the discharge nozzle. This allowed a reduction in turbulence before water entered the discharge nozzle, but such a discharge pipe is heavy and cumbersome because it must be quite long.

More recent designs include longitudinal fins or vanes inside of the turbulence reducing discharge pipe. The vanes permit a reduction in length, but there is a practical limit on the number of vanes that can be used because they increase friction losses by restricting flow. An example of such a prior art device is shown in FIGS. 8 and 9 where cylindrical discharge pipe 2 has longitudinally extending perpendicular diametral webs 3 and 4 that divide the pipe interior into four equal quadrants or longitudinal passages. Each quadrant or passage has circumferentially-spaced vanes extending radially inwardly from the interior of the pipe wall, and only two such vanes are indicated by numerals 5, 6 in FIG. 9. A typical discharge pipe with turbulence reducing features of this type has a nominal internal diameter of 2.5 inches and a nominal overall length of 8.0 inches.

It would be desirable to have a smaller turbulence reducing discharge pipe that does not unduly restrict fluid flow.

### SUMMARY OF THE INVENTION

A turbulence reducing device in accordance with the present application is referred to as a stream shaper, and includes a plurality of circumferentially-spaced vanes, with alternate vanes being axially-spaced from the remaining vanes. This provides vane groups that are axially-spaced for providing reassembly of individual streams from one vane group into a single stream before entering the other vane group.

The fluid flow restriction at any cross section along the entire length of the stream shaper is only one-half of the restriction that would exist in a stream shaper having the same number of vanes extending the full length thereof.

In one arrangement, the vanes are circumferentially-spaced equidistantly from one another, and vanes in one vane group are located midway between the vanes in the other vane group.

The stream shaper includes inner and outer cylindrical walls, and an axial cylindrical passage extends through the inner cylindrical wall. In one arrangement, a single ring of individual passages are provided between the inner and outer cylindrical walls by circumferentially-spaced vanes that extend radially of the stream shaper longitudinal axis between the inner and outer cylindrical walls.

The stream shaper of the present application is fixed in position within a cylindrical passage, and does not move in any direction.

The much shorter axial length of the stream shaper of the present application as compared to prior arrangements also provides significant reduction in friction losses.

It is a principal object of the present invention to provide a stream shaper that is very short in length.

It is another object of the invention to provide a stream shaper that minimizes flow restriction.

It is also an object of the invention to provide a stream shaper that is fabricated in one-piece.

It is a further object of the invention to provide a stream shaper that is small and does not significantly increase the weight of a nozzle or make it more difficult to manipulate the nozzle.

It is an additional object of the invention to provide a stream shaper that reduces turbulence to provide more laminar flow in an efficient and cost effective manner.

### BRIEF DESCRIPTION OF THE DRAWING

FIG. 1 is a side elevational view of a stream shaper in accordance with the present application;

FIG. 2 is an end elevational view thereof taken on line 2-2 of FIG. 1;

FIG. 3 is a cross-sectional elevational view taken generally on line 3-3 of FIG. 2;

FIG. 4 is a cross-sectional elevational view taken generally on line 4-4 of FIG. 2;

FIG. 5 is an end elevational view of another embodiment;

FIG. 6 is a cross-sectional elevational view taken generally on line 6-6 of FIG. 5;

FIG. 7 is a cross-sectional elevational view of the embodiment of FIGS. 5 and 6 installed in a discharge pipe at the entrance to a discharge nozzle;

FIG. 8 is a side elevational view of a prior art turbulence reducing discharge pipe; and

FIG. 9 is an end elevational view thereof.

### DESCRIPTION OF A PREFERRED EMBODIMENT

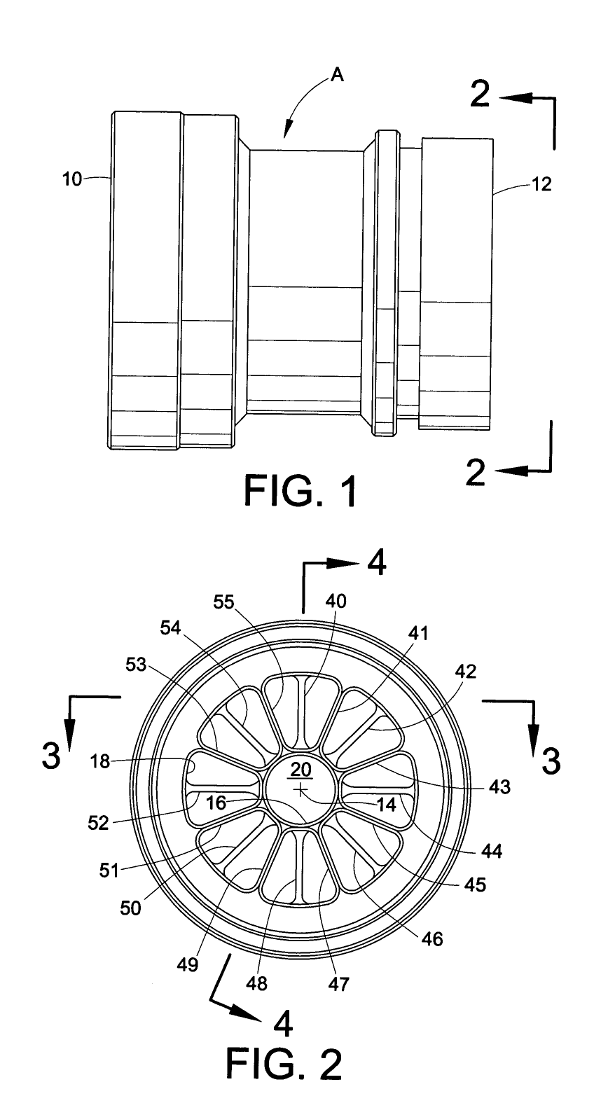

Referring now to the drawings, wherein the showings are for purposes of illustrating certain preferred embodiments of the invention only and not for purposes of limiting same, FIG. 1 shows a stream shaper in the form of a generally cylindrical discharge pipe to which a discharge nozzle is connectable. In the arrangement shown, liquid flows from an inlet end 10 toward a discharge end 12, although it will be appreciated that the flow direction can be reversed while achieving the same performance.

The interior of stream shaper A has a plurality of longitudinal passages extending therethrough parallel to central longitudinal axis 14. The interior of stream shaper A includes inner and outer cylindrical walls 16, 18 and a central cylindrical passage 20 extends through inner cylindrical wall 16.

Vanes 40-55 extend between inner and outer cylindrical walls 16, 18 radially of and parallel to longitudinal axis 14. The alternate or odd numbered vanes are axially displaced with respect to the remaining or even numbered vanes so that there are two separate vane groups generally indicated by letters B, C that are axially-separated from one another by an axial space 60.

All of the vanes are circumferentially-spaced equidistantly from one another and the vanes in one vane group are centered between the vanes in the other vane group. In the arrangement shown, there are a total of sixteen vanes, with eight vanes in each vane group. Thus, the stream shaper has a total of sixteen individual passages between all of the vanes and a total of eight individual passages between the vanes in each vane group. Obviously, the number of vanes may vary.

The vanes are generally flat, and have a uniform thickness radially and axially of axis 14, but are thicker where they merge with inner and outer cylindrical walls 16, 18 at smoothly curved radii. The vane surfaces and the other interior surfaces of the stream shaper preferably are hardcoated, and have a smooth 63-125 micron finish. The vane groups preferably are of the same length, although it will be appreciated that one vane group can be longer or shorter than the other.

A liquid stream entering inlet vane group B is divided into eight individual streams by the even numbered vanes plus one central stream flowing through central cylindrical passage 20. The individual streams flow through passages defined between each adjacent pair of even numbered vanes in inlet vane group B. Axial space 60 has a length sufficient to provide reassembly of the eight individual streams from inlet vane group B into a single stream before entering discharge vane group C.

Due to the circumferential displacement between vane groups B and C, a small single stream flowing between a pair of adjacent vanes in inlet vane group B is in effect positioned to be equally split to flow through two adjacent passages on opposite sides of one vane in discharge vane group C. Central passage 20 is continuous through the entire stream shaper, and is not interrupted by space 60 between vane groups B, C.

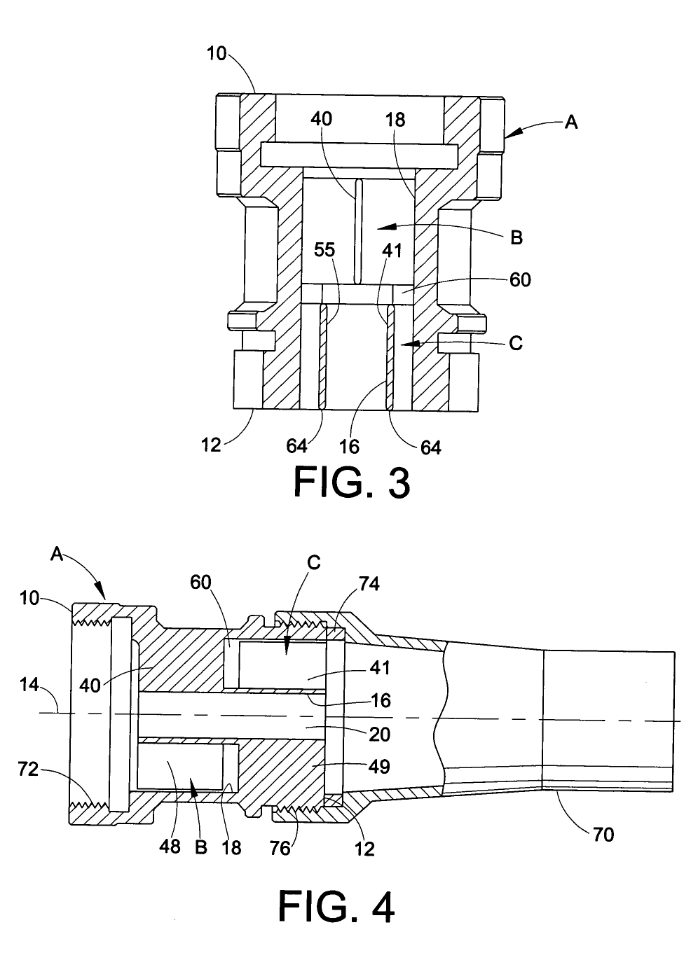

The exit ends of the even numbered vanes in discharge vane group C preferably are rounded or tapered as generally indicated at 64 in FIG. 3 to facilitate reassembly of the individual streams flowing through discharge vane group C into a large single stream by way of the coanda effect. The inlet ends of the odd numbered vanes also may be rounded or tapered.

The size of central cylindrical passage 20 preferably is approximately the same size as each individual passage between adjacent vanes in each vane group. The cross-sectional area of passage 20 does not vary by more than twenty percent from the area of an individual passage between two adjacent vanes in one vane group, more preferably by not more than ten percent, and most preferably by not more than five percent.

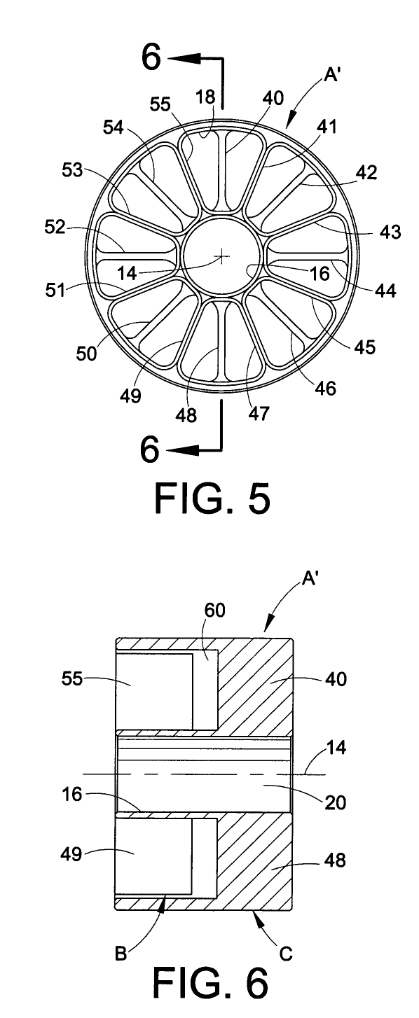

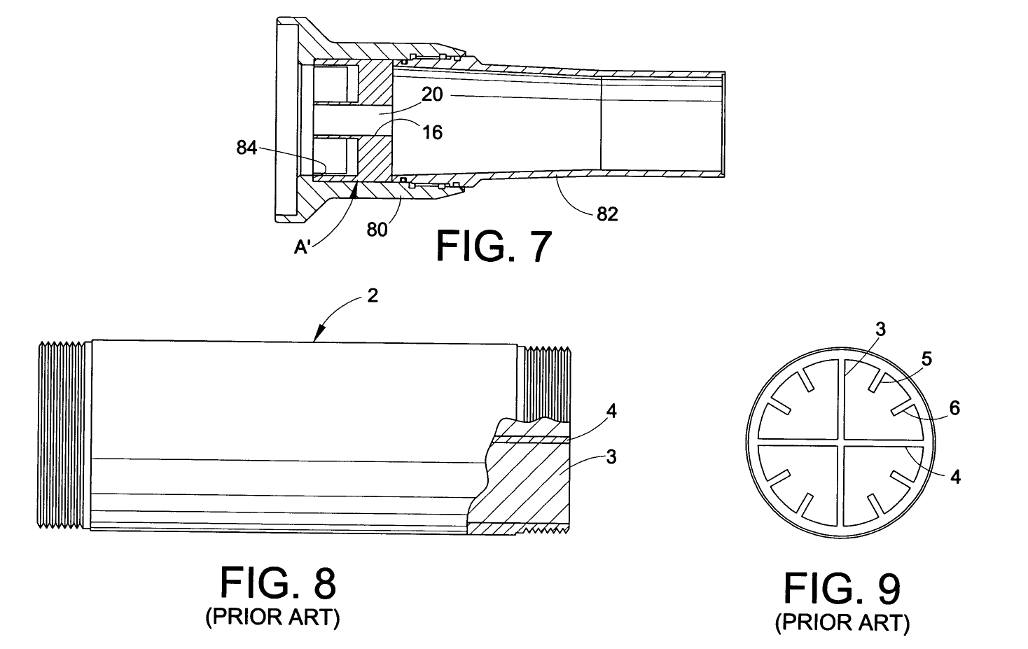

The embodiment of FIGS. 5-7 is designated A′, and common numerals are used for features that are the same as the embodiment of FIGS. 1-4. In the embodiment of FIGS. 1-4, the stream shaper is formed integrally with the discharge pipe that attaches to the inlet of discharge nozzle 70 that is threaded into stream shaper A as generally indicated at 72. A suitable gasket 74 is provided for sealing against the end of discharge nozzle 70. The opposite end of stream shaper A is externally threaded as generally indicated at 76 for attachment to a valve housing.

In the embodiment of FIGS. 5-7, stream shaper A′ is a separate one-piece insert that is positioned within a discharge pipe 80 to which a discharge nozzle 82 is attached. One end of stream shaper insert A′ is urged against an internal shoulder 84 within discharge pipe 80 by the end of nozzle 82 acting against the opposite end of stream shaper insert A′ as the nozzle is internally threaded into discharge pipe 80. The insert may be made reversible by rounding or tapering the outer ends of the vanes in both vane groups so that the vane groups can be either inlet or discharge vane groups.

Individual liquid streams flowing through a passage between adjacent vanes in one vane group has velocity vectors parallel to the longitudinal axis of the stream shaper and velocity vectors internal of the stream that are not parallel to the longitudinal axis. When the individual streams from one vane group are in effect again divided equally as they flow through the other vane group, more of the non-parallel velocity vectors are straightened out so as to be parallel to the longitudinal axis of the stream shaper.

The cylindrical inner surface of outer cylindrical wall 18 defines the outer periphery of the vanes and also defines the outer periphery of the passages through the vanes. The outer cylindrical surface of inner cylindrical wall 16 defines the cylindrical inner periphery of the vanes and of the passages through the vanes.

The dimensions of a stream shaper in accordance with the present application may vary significantly, and examples of dimensions will be given simply by way of illustration rather than by way of limitation. The overall length of combined discharge pipe and stream shaper A of FIGS. 1-4 is approximately 4.047-4.077 inches. The axial length of each vane group B, C is approximately 1.360-1.390 inches. The thickness of each vane is approximately 0.58-0.68 inches. The diameter of central cylindrical passage 20 is approximately 0.742-0.758 inches. The vanes in each vane group are angularly spaced on 45° centers and the vanes of one group are circumferentially offset by 22 1/2° so that the angular spacing between vanes in both groups as viewed in FIG. 2 is 22½°.

The diameter of the inner surface of outer cylindrical wall 18 is approximately 2.459-2.479 inches. Axial space 60 between vane groups preferably is made just long enough so that individual streams exiting inlet vane group B will reassemble into a single stream before entering discharge vane group C. This spacing dimension may vary, and in the arrangement described, is approximately 0.150-0.350 inches or usually around one-fourth to one-eighth the length of one vane group.

The length of axial space 60 will vary depending on the size of the stream shaper and the velocity of the fluid flowing through it. Preferably, the space is just long enough to permit reassembly of individual small streams from one vane group into a single large stream before entering the other vane group. The space could be somewhat longer, but that just increases the overall length of the stream shaper without providing any increased performance. For some purposes, or where optimum performance is not required, space 60 may be somewhat less than that required to allow complete reassembly of the individual small streams into a single large stream before entering the other vane group.

In the embodiment of FIGS. 5-7, the overall length of stream shaper insert A′ is 1.747-1.752. The outer diameter is 2.730-2.740. The diameter of the inner surface of outer cylindrical wall 18 is 2.490-2.510. The diameter of central cylindrical passage 20 is 0.742-0.758 inches. The length of each vane group is 0.735-0.765. The vane thickness is 0.063-0.073.

The central cylindrical passage preferably has a size that is approximately the same as a passage through two adjacent vanes in one vane group. In one arrangement, the diameter of central passage 20 is not greater than approximately one-third of the diameter of the inner surface of outer cylindrical wall 18.

In the arrangement shown and described, vane groups B, C also define stream dividers that divide a single large stream into a plurality of individual smaller streams. The stream dividers B, C are circumferentially offset relative to one another such that smaller streams formed by one stream divider are circumferentially offset relative to smaller streams formed by the other stream divider. Preferably, the smaller streams formed by one stream divider are centered between adjacent pairs of smaller streams formed by the other stream divider. Each stream divider B, C divides a single cylindrical stream into a smaller central stream and a plurality of circumferentially-spaced smaller outer streams that surround the central stream.

With the vane groups B, C defining axially aligned stream dividers, each stream divider has a plurality of circumferentially-spaced axial passages. The two stream dividers are circumferentially rotated relative to one another to position the passages in one stream divider in overlapping relationship with a plurality of adjacent passages in the other stream divider. Each passage in one stream divider preferably overlaps one-half of two adjacent passages in the other stream divider. The small streams or passages in the stream dividers preferably are arranged in a single ring between a central passage and an outer periphery. Although other arrangements are possible, the streams or passages preferably all have approximately the same size and each stream divider has the same number of passages.

The stream shaper preferably is machined in one-piece out of metal such as aluminum or brass. However, it will be appreciated that other materials may be used for some purposes, and that the stream shaper may be fabricated in several separate pieces that are assembled or otherwise positioned in cooperative relationship to practice the advantageous principals of the present application. While the stream shaper has been shown and described with two vane groups, it will be recognized that additional vane groups could be provided in situations where the additional friction losses can be tolerated.

The stream shaper of the present application is fixed in position within a cylindrical passage, and does not move in any direction, including rotatably, relative to the walls of the passage in which it is located.

The stream shaper of the present application is particularly advantageous for use with water and other liquids. However, it will be appreciated that the principals of the present application can be used with fluids other than liquids.

Although the invention has been shown and described with reference to preferred embodiments, it is obvious that alterations and modifications will occur to others skilled in the art upon the reading and understanding of this application. Therefore, it is to be understood that the invention may be practiced otherwise than as specifically described herein while remaining within the scope of the claims.

1. A stream shaper having a pair of axially-spaced vane groups, each vane group having a plurality of circumferentially-spaced axially extending vanes, and said vanes in one of said vane groups being circumferentially offset relative to said vanes in the other of said vane groups.

2. The stream shaper of claim 1 including inner and outer cylindrical walls, said vanes extending radially between said inner and outer cylindrical walls.

3. The stream shaper of claim 2 wherein said inner cylindrical wall has an axially extending cylindrical passage therethrough.

4. The stream shaper of claim 1 wherein each said vane group has an equal number of vanes and said vanes in each vane group are circumferentially-spaced equidistantly, said vanes in one vane group being centered between said vanes in the other of said vane groups.

5. The stream shaper of claim 1 wherein each vane group has eight vanes.

6. The stream shaper of claim 1 wherein said vane groups are axially-spaced a distance that provides reassembly of liquid streams flowing through one of said vane groups into a single liquid stream prior to flowing through the other of said vane groups.

7. The stream shaper of claim 1 wherein said stream shaper is of one-piece construction.

8. The stream shaper of claim 1 wherein said vanes have a smooth finish.

9. The stream shaper of claim 1 wherein one of said vane groups is an exit vane group, and said vanes in said exit vane group having tapered discharge ends.

10. The stream shaper of claim 9 wherein said tapered discharge ends are rounded.

11. The stream shaper of claim 1 wherein said vane groups are of equal axial length.

12. The stream shaper of claim 1 wherein said vanes have an outer diameter and said vane groups have an inner cylindrical wall with an axially extending cylindrical passage therethrough, and said cylindrical passage having a diameter that is not greater than one-third of said outer diameter.

13. The stream shaper of claim 1 wherein said vane groups are spaced-apart between 0.150-0.350 inches.

14. The stream shaper of claim 1 wherein said vane groups have vane passages between adjacent vanes, said stream shaper having an inner central cylindrical passage, and said central cylindrical passage having a cross-sectional area that is within twenty percent of the cross-sectional area of each of said vane passages.

15. A stream shaper having axially-spaced groups of flow passages, each group of passages including a plurality of circumferentially-spaced individual flow passages, said flow passages in one of said groups of flow passages being circumferentially offset relative to said flow passages in the other of said groups of flow passages so that fluid flowing through an individual flow passage in one of said groups of flow passages flows through a plurality of individual flow passages in the other of said groups of flow passages.

16. The stream shaper of claim 15 wherein said axially-spaced groups of flow passages include axially aligned central flow passages.

17. The stream shaper of claim 15 wherein said axially-spaced groups of flow passages are spaced-apart such that fluid flowing through said flow passages in one of said groups of flow passages reassembles into a single stream prior to flowing through said flow passages in the other of said groups of flow passages.

18. The stream shaper of claim 15 wherein said individual flow passages in said axially-spaced groups of flow passages are formed by a plurality of axially-extending circumferentially-spaced vanes that extend radially of the stream shaper axis.

19. The stream shaper of claim 15 wherein said axially-spaced groups of flow passages have approximately the same axial length and the same number of flow passages.

20. The stream shaper of claim 15 wherein said flow passages include centrally located aligned flow passages in said axially-spaced groups of flow passages, the reminder of said flow passages in said groups of flow passages being circumferentially-spaced around said centrally located aligned flow passages.

21. The stream shaper of claim 20 wherein said groups of flow passages have an outer periphery and said remainder of said flow passages comprise a single ring of flow passages between said centrally located aligned flow passages and said outer periphery.

22. A stream shaper having axially-spaced stream dividers that divide a single stream into a plurality of smaller streams, each stream divider including inner and outer cylindrical walls, a plurality of vanes circumferentially-spaced equidistantly between said inner and outer cylindrical walls, said inner cylindrical wall having a flow passage therethrough with a longitudinal axis, said vanes extending radially of and parallel to said axis, and said vanes in one of said stream dividers being circumferentially displaced relative to the vanes in the other of said stream dividers so that the vanes in one stream divider are approximately midway between the vanes in the other stream divider.

23. The stream shaper of claim 22 wherein said stream dividers are axially-spaced a sufficient distance to provide reassembly of the individual streams from one of the stream dividers into a single stream prior to flowing through the other stream divider.

24. A stream shaper having axially-spaced stream dividers that divide a single stream into a plurality of smaller streams, said stream dividers being circumferentially offset relative to one another such that smaller streams formed by one stream divider are circumferentially offset relative to smaller streams formed by the other stream divider.

25. The stream shaper of claim 24 wherein said stream dividers are circumferentially offset such that smaller streams formed by one stream divider are centered between adjacent pairs of smaller streams in the other stream divider.

26. The stream shaper of claim 24 wherein said stream dividers are axially spaced to provide reassembly of the smaller streams from one stream divider into a single stream prior to flowing through the other stream divider.

27. The stream shaper of claim 24 wherein each of said stream dividers divide a single cylindrical stream into a smaller central stream and a plurality of circumferentially-spaced smaller outer streams that surround said central stream.

28. A stream shaper having at least two axially aligned stream dividers, each stream divider having a plurality of circumferentially-spaced axial passages, said stream dividers being circumferentially rotated relative to one another to position the passages in one stream divider in overlapping relationship with a plurality of passages in the other stream divider.

29. The stream shaper of claim 28 wherein the passages in one stream divider are in overlapping relationship with a pair of passages in the other stream divider.

30. The stream shaper of claim 29 wherein each passage in one stream divider overlaps one-half of two adjacent passages in the other stream divider.

31. The stream shaper of claim 28 including a central passage in each stream divider, the remainder of the passages in each stream divider being circumferentially-spaced around said central passage.

32. The stream shaper of claim 31 wherein each stream divider has an outer periphery and the remainder of the passages in each stream divider are arranged in a single ring of passages between said central passage and said outer periphery.

33. The stream shaper of claim 28 wherein said passages are of approximately equal size.

34. The stream shaper of claim 28 wherein each stream divider has the same number of passages.

35. The stream shaper of claim 28 wherein said stream dividers are axially-spaced from one another.

36. The stream shaper of claim 35 wherein said stream dividers are axially-spaced a distance that provides reassembly of a plurality of streams flowing through one of said stream dividers into a single stream prior to flowing through the other of said stream dividers.

37. A stream shaper having a longitudinal axis, a plurality of vanes that are circumferentially-spaced equidistantly from one another and extend radially of and parallel to said axis, alternate ones of said vanes being axially-paced from the remaining vanes.
